(19) United States
(12) Patent Application Publication
(10) Pub. No.: US 2007/0070985 A1
(43) Pub. Date: Mar. 29, 2007

(54) System and Method for Integrating Internet Phone to Ordinary Phone

(76) Inventor: Ing-Kai Huang, Hsinchu City (TW)

Correspondence Address: HDSL, 4331 STEVENS BATTLE LANE, FAIRFAX, VA, 22033, US

(21) Appl. No.: 11/468,608

(22) Filed: Aug. 30, 2006

(30) Foreign Application Priority Data
Sep. 28, 2005 (TW) 094133695

(51) Int. Cl. H04L 12/66

(52) U.S. Cl. 370/352

(57) ABSTRACT

An Internet phone dials a server through Internet and the sever analyzes an incoming call of the Internet phone for identifying a network system for the Internet phone. The server distributes corresponding application program to personal computer at user site through LAN. The user site receives phone call through personal computer. Alternatively, the processed Internet phone signal is sent to the server and the signal is sent to the PBX after analog to digital conversion of the gateway box. The PBX sends the address number from the calling party to the conventional phone of the called party to achieve communication between Internet phone and conventional phone. When user dials Internet phone, he selects Internet phone program through computer and clicks Internet phone number or account, or he directly dials through a conventional phone, whereby the conventional phone at user site can communicate with Internet phone.

### BACKGROUND OF THE INVENTION

1. Field of the Invention

The present invention relates to a system and a method for integrating Internet phone to ordinary phone, especially to a system and a method for integrating Internet phone to ordinary phone so that an ordinary phone can be used as an Internet phone.

2. Description of Prior Art

The conventional telephones and mobile phones play important roles for communication between people, especially for people with far separation. Therefore conventional telephones and mobile phones are omnipresent in ordinary life.

However, the fee for domestic call, long-distance call, and inter-territorial call is counted on time base, namely, by minute or second, which is usually high for user. Therefore, the service provider usually offers discount period for user, which is a particular time such as midnight.

Moreover, as the prevailing of Internet, Internet phones such as Skype, MSN, AOL, Peer-Call, or SIP phone are alternative choices for users. These Internet phones allow people have vocal conversation with remote party at the expense of Internet connection fee only.

However, the existing Internet phones request both parties (calling party and called party) to have the access ability of computer or Internet phone, which is inconvenient for user.

Moreover, the current Internet phone allows users to conversation through Internet at the expense of Internet fee. However, the Internet phone is mainly for business use and cannot enable user to call police or make emergent call. It is still inconvenient to user.

### SUMMARY OF THE INVENTION

The present invention is to provide a system and method for integrating Internet phone to ordinary phone, whereby a conventional phone can answer and make a phone call to Internet phone.

The present invention provides a system and method for integrating Internet phone to ordinary phone. The method comprises following steps:

an Internet phone dialing a server through Internet and a program in the sever analyzing an Internet phone signal of an incoming call of the Internet phone in term of incoming call protocol and identifying a network system for the Internet phone, the server selecting a corresponding application program and a default processing rule for the incoming call, the server judging a user site for the Internet phone by comparing the incoming call with data stored in a phone book system;

by comparing data in the phone book system, an application program being distributed to personal computers at user site through local area network, whereby user can receives phone call in personal computer and a returned Internet phone signal is sent from the personal computer to the server through the local area network;

the gateway box performing analog to digital conversion for the Internet phone signal and echo processing and then sending the processed signal to a public switch box (PBX), the PBX sending the processed signal to a user telephone according to a first address number in a processed result of the server; an audio signal in the user telephone being sent to the gateway box through the PBX, the gateway box performing analog to digital conversion and echo processing for the audio signal and then sending the processed audio signal to the server through the USB interface, the processed audio signal being sent to external Internet phone through Internet, whereby communication between a calling party and a called party can be established.

when dialing the Internet phone at user site, selecting corresponding Internet phone application program by personal computer and performing dialing number or account for Internet phone or mobile phone, a dialing is sent through local area network to server for connecting to an Internet phone or a mobile phone, whereby a user can communicate with the Internet phone or the mobile phone through a personal computer or a telephone; and

when dialing the Internet phone by using telephone at user site: an external signal is sent to the gateway box through the PBX and then sent to the server through USB, the server selecting a corresponding Internet phone program, whereby calling party and called party can communicate through Internet.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of an apparatus for integrating an Internet phone to an ordinary phone system.

FIG. 2 shows a flowchart for the operation of sever in the present invention.

FIG. 3 shows a flowchart of the dialing process at user site.

### DETAILED DESCRIPTION OF THE INVENTION

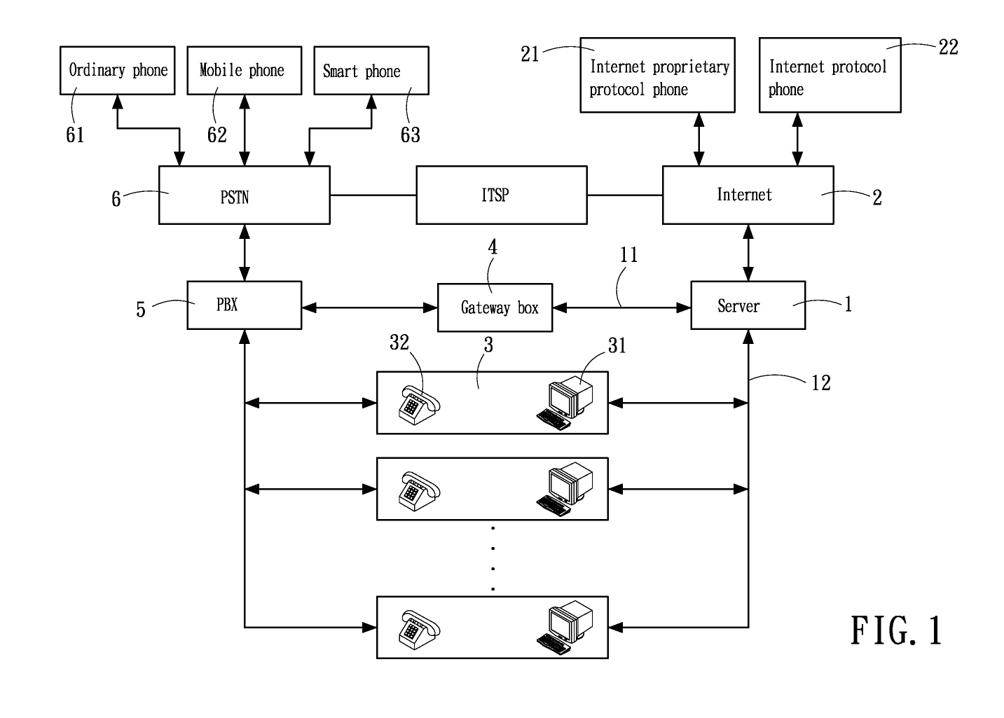

FIG. 1 shows the block diagram of an apparatus for integrating an Internet phone to an ordinary phone system. The signal of Internet phone can be integrated to the ordinary phone system besides receiving through personal computer or Internet phone. Therefore, the user can use ordinary phone to dial an Internet phone, or dials an ordinary phone through an Internet phone.

The apparatus for integrating an Internet phone to an ordinary phone system comprises a server 1, which is a network server and connected to Internet proprietary protocol phone 21 (such as Skype, MSN AOL, YAHOO, Google, ICQ, YAMQQ, Peer-call) and Internet protocol phone 22. The server 1 is connected to a gateway box 4 through a Universal Serial Bus (USB) 11. The server 1 is connected to a PC 31 at user site 3 through a local area network (LAN) 12. A phone book system is provided within the server 1 and is functioned to store external Internet phone number, Internet phone account, mobile phone number, household phone number, company phone number and extension number. The phone book system is also functioned to store Internet phone number, Internet phone account, mobile phone number, company phone number and extension number for the user site 3. The server 1 can be a personal computer or an embedded system and comprises personal database and various Internet phone application programs. Therefore, the server 1 can be connected to home or small company without using local area network.

The user site 3 comprises a personal computer 31 and an ordinary phone 32. The personal computer 31 is electrically connected to the server 1 through the LAN 12 and the ordinary phone 32 is electrically connected to the public switch box (PBX) 5.

The gateway box 4 is electrically connected to the server 1 through the USB 11 and is functioned for digital/analog signal conversion and eliminating echo. The gateway box 4 converts a digital signal to an analog signal and then sends the analog signal to the PBX 5. The gateway box 4 converts an analog signal sent by the PBX 5 to a digital signal and sends the digital signal to the server 1. When the gateway box 4 performs signal conversion, the gateway box 4 also eliminates echo in signal such that users can clearly listen to each other. Moreover, the gateway box 4 and the server 1 can be connected through other wired medium besides USB 11, for example, by IEEE1394 or 802.11. Moreover, the gateway box 4 can be an embedded system to perform grid computing with the server 1.

The PBX 5 is an automatic PBX and the user sends the address of the called party for automatically selecting line. The gateway box 4, the telephone 32, the Public Switched Telephone Network (PSTN)6 and the PBX 5 are ordinary art and the detailed description thereof is omitted here for clarity. The user site 3 uses the telephone 32 for calling and the calling is converted through the PBX 5, the PSTN 6 and then to one of external telephone 61, mobile phone 62 and smart phone 63. Alternatively, the calling is converted through the PBX 5, the gateway box 4 and the server 1. Alternatively, the calling is directly converted through the personal computer 31, the Internet 2 to the Internet proprietary protocol phone 21 or the Internet protocol phone 22.

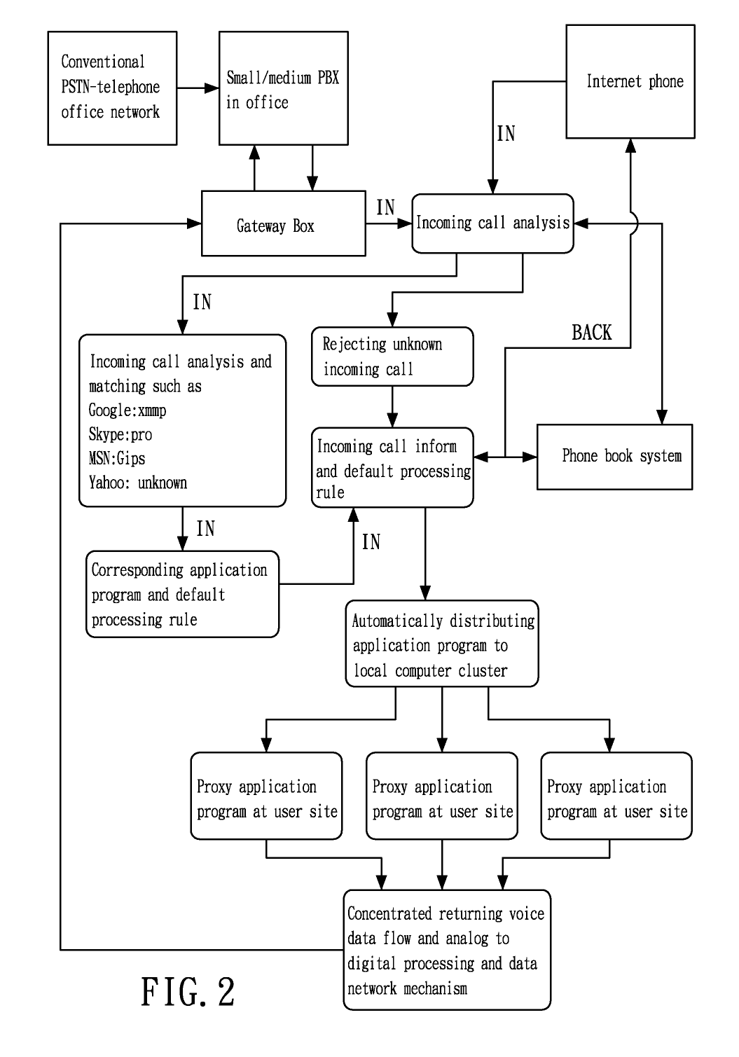

With reference to FIGS. 1 and 2, the server 1 will perform following process to integrate the Internet phone to the ordinary phone system. After the Internet proprietary protocol phone 21 or the Internet protocol phone 22 sends an incoming call to the server 1 through the Internet 2, the server 1 will perform incoming call analysis to compare the protocol of the incoming call and identify the protocol of the Internet proprietary protocol phone 21 or the Internet protocol phone 22. For example, the protocol can be one of Skype, MSN, AOL, YAHOO, Google, ICQ, YAMQQ, Peer-call and SIP phone.

If the protocol of the incoming call is identified as one of above-mentioned protocols, the server 1 will selects corresponding application program and default processing rule. The server 1 further refers to the phone book system to identify the user site 3 called by the Internet proprietary protocol phone 21 or the Internet protocol phone 22. The application program is automatically distributed to the personal computer 31 through the LAN 12 and with reference to the phone book system. The application program is executed by the personal computer 31 such that user can directly answer the phone on the personal computer 31. Alternatively, the Internet phone signal processed by the personal computer 31 is sent to the server 1 through the LAN 12.

The server 1 sends signal to the gateway box 4 through USB 11 and the gateway box 4 converts the digital signal of the Internet phone to analog signal and eliminate the echo in the signal. The signal is sent to the PBX 5 and the PBX 5 transfers the call to the telephone 32 of client site 3 according to the analysis result (such as extension number) of the server 1. If nobody answers the call to telephone 32 of user site 3, the PBX 5 transfers the call to another extension or the calling party inputs again new extension number and the PBX 5 helps to transfer the call to phone of new extension number.

If the call to the telephone 32 of user site 3 is picked up, the voice signal of the called party at the client site 3 is sent to the PBX 5 through the telephone 32 and then sent to the gateway box 4 through the PBX 5. The gateway box 4 processes the analog voice signal into digital signal and also processes the echo. The processed digital signal is sent to the server through the USB 11 and then sent to the Internet proprietary protocol phone 21 or the Internet protocol phone 22 through the Internet 2 for establish conversation between calling party and called party.

When the external Internet proprietary protocol phone 21 or Internet protocol phone 22 is dialed to the server 1 through the Internet 2 and the server 1 analyzes the incoming call, the server 1 will not receive call from unknown number if the number of the external Internet proprietary protocol phone 21 or Internet protocol phone 22 is not in the phone book system.

When a user at the user site 3 uses the telephone 32 to call an ordinary phone 61 and the external phone number is dialed, the call is connected to PSTN 6 through the PBX 5. The call can be connected one of the ordinary phone 61, the mobile phone 62 and a smart phone 63.

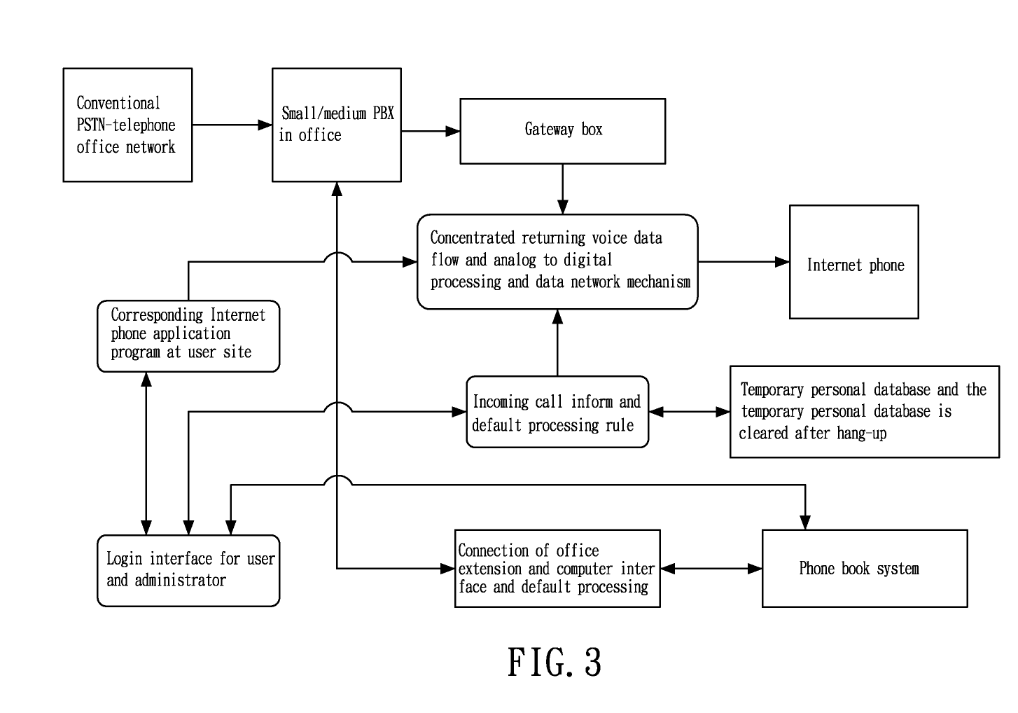

As shown in FIGS. 2 and 3, the procedure of method for integrating an Internet phone to an ordinary phone system is shown. The user or administrator at user site 3 inputs telephone number or user account corresponding to the Internet proprietary protocol phone 21, mobile phone or Internet protocol phone 22 through the administration interface of personal computer. The telephone number or user account are stored in the phone book system through Internet 12.

When user at the user site 3 wants to dial the Internet proprietary protocol phone 21, he can click corresponding Interne phone program in the personal computer 31 and the Internet proprietary protocol phone 21 or Internet protocol phone 22 is dialed. Alternatively, the number of mobile phone or account is dialed and the call is sent to the server 1 through Internet 12. After the processing of the server 1, the call is sent to the Internet proprietary protocol phone 21 or Internet protocol phone 22 or mobile phone. At this time, the computer at user site 3 can be connected with the Internet proprietary protocol phone 21 or Internet protocol phone 22 or mobile phone. At this time, the user at user site 3 can communicate with the Internet proprietary protocol phone 21 or Internet protocol phone 22 or mobile phone by using the personal computer 31 or telephone 32.

When the user at user site 3 dials the Internet proprietary protocol phone 21 or Internet protocol phone 22 through the telephone 32, the external dialing signal is sent to the gateway box 4 through the PBX 5. The gateway box 4 performs analog to digital conversion for the signal and eliminate echo in the signal and then sends the processed signal to the server 1 through the USB 11. The server 1 analyzes corresponding Internet phone program and then connect to the Internet proprietary protocol phone 21 or Internet protocol phone 22 through Internet 2.

Moreover, when the calling party is connected with the called party through Internet phone, a temporary data base for client site is built within the server 1 and the temporary data base is cleared when the user at client site 3 ceases talking or hangs up.

Moreover, a set of emergence or police alarm telephones are established in the phone book system of the server 1. Therefore, user can make emergence call by the Internet phone program when the conventional telephone system is crushed or malfunctioned.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for integrating Internet phone to ordinary phone, comprising the steps of:
a) an Internet phone dialing a server through Internet and a program in the sever analyzing an Internet phone signal of an incoming call of the Internet phone in term of incoming call protocol and identifying a network system for the Internet phone, the server selecting a corresponding application program and a default processing rule for the incoming call, the server judging a user site for the Internet phone by comparing the incoming call with data stored in a phone book system;
b) by comparing data in the phone book system, an application program being distributed to a personal computer at user site through a local area network, whereby user can receives a phone call in the personal computer and a returned Internet phone signal is sent from the personal computer to the server through the local area network;
c) the Internet phone signal being sent to a gateway box through a USB interface, the gateway box performing analog to digital conversion for the Internet phone signal and echo processing and then sending the processed signal to a public switch box (PBX), the PBX sending the processed signal to a user telephone according to a first address number in a processed result of the server;
d) after the user telephone being picked up, an audio signal in the user telephone being sent to the gateway box through the PBX, the gateway box performing analog to digital conversion and echo processing for the audio signal and then sending the processed audio signal to the server through the USB interface, the processed audio signal being sent to external Internet phone through Internet, whereby communication between a calling party and a called party is established.

2. The method for integrating Internet phone to ordinary phone as in claim 1, wherein the Internet phone is one of Internet proprietary protocol phone and Internet protocol phone.

3. The method for integrating Internet phone to ordinary phone as in claim 2, wherein the Internet proprietary protocol phone is one of Skype, MSN, AOL, YAHOO, Google, ICQ, YAMQQ, and Peer-call.

4. The method for integrating Internet phone to ordinary phone as in claim 2, wherein the Internet protocol phone is SIP phone.

5. The method for integrating Internet phone to ordinary phone as in claim 1, further comprising the step of:
when nobody answers the user telephone at the user site, the PBX will automatically transform the call to another address number or the calling party inputs again new address number and the PBX transfers the call to phone of new address number.

6. The method for integrating Internet phone to ordinary phone as in claim 1, further comprising the step of:
the incoming call from the Internet phone identified as unknown incoming when the incoming call is not associated with number or account stored in the phone book system, the server will rejects the unknown incoming call.

7. The method for integrating Internet phone to ordinary phone as in claim 1, further comprising the step of:
when users wants to dial an external ordinary phone by using telephone at user site, a call is sent to a public switched telephone network (PSTN) through the PBX for connecting to an external ordinary phone, wherein the external ordinary phone is one of conventional telephone, mobile phone and smart phone.

8. The method for integrating Internet phone to ordinary phone as in claim 1, wherein the phone book system stores external Internet phone number, Internet phone account, mobile phone number, household phone number, company phone number and extension number, the phone book system also stores Internet phone number, Internet phone account, mobile phone number, company phone number and extension number at the user site.

9. The method for integrating Internet phone to ordinary phone as in claim 1, further comprising the step of:
when the calling party is connected with the called party through Internet phone, a temporary data base for client site is built within the server and the temporary data base is cleared when the user at client site ceases talking or hangs up.

10. The method for integrating Internet phone to ordinary phone as in claim 1, further comprising the step of:
establishing a set of emergence or police alarm telephones in the phone book system of the server, whereby user can make emergence call by the Internet phone program when the conventional telephone system is crushed or malfunctioned.

11. The method for integrating Internet phone to ordinary phone as in claim 1, wherein the server is a personal computer or an embedded system and integrated with personal database and Internet telephone application program whereby home or small company can be accessed without using local area network.

12. The method for integrating Internet phone to ordinary phone as in claim 1, further comprising the step of:
user or administrator at user site inputting telephone number and account of Internet phone through input interface and the telephone number and account are stored in phone book system through local area network.

13. The method for integrating Internet phone to ordinary phone as in claim 1, wherein the server is communicated with gateway box through USB or other wired medium or wireless medium such as IEEE1394 and 802.11.

14. The method for integrating Internet phone to ordinary phone as in claim 1, wherein the gateway box can be an embedded system for performing grid computing with the server.

15. The method for integrating Internet phone to ordinary phone as in claim 1, further comprising the step of:
a) dialing the Internet phone at user site: selecting corresponding Internet phone application program by personal computer and performing dialing number or account for Internet phone or mobile phone, a dialing is sent through local area network to server for connecting to an Internet phone or a mobile phone, whereby a user can communicate with the Internet phone or the mobile phone through a personal computer or a telephone;
b) dialing the Internet phone by using telephone at user site: an external signal is sent to the gateway box through the PBX and then sent to the server through USB, the server selecting a corresponding Internet phone program, whereby calling party and called party can communicate through Internet.

16. A system using the method for integrating Internet phone to ordinary phone as in claim 1, comprising:
a server connected to Internet and comprising application program for various Internet phones and a phone book system;
a gateway box electrically connected to the server and used for analog to digital conversion;
a PBX electrically connected to the gateway box and automatically selecting a line for a dialing number;
at least one user site comprising a personal computer and a telephone, the personal computer being electrically connected to the server and the telephone being electrically connected to the PBX.

17. The system as in claim 16, wherein the Internet phone is one of Internet proprietary protocol phone and Internet protocol phone.

18. The system as in claim 17, wherein the Internet proprietary protocol phone is one of Skype, MSN, AOL, YAHOO, Google, ICQ, YAMQQ, and Peer-call.

19. The system as in claim 17, wherein the Internet protocol phone is SIP phone.

20. The system as in claim 16, wherein the gateway box eliminates echo besides performing analog to digital conversion.

21. The system as in claim 16, wherein the gateway box is electrically connected to the server through USB interface.

22. The system as in claim 16, wherein the personal computer is electrically connected to the server through local area network.

23. The system as in claim 16, wherein the PBX is electrically connected to PSTN for communicating with one of external conventional phone, mobile phone or smart phone.
